(19) United States
(12) Patent Application Publication
(10) Pub. No.: US 2019/0118366 A1
(43) Pub. Date: Apr. 25, 2019

(54) APPARATUS FOR USE WITH A POWER TOOL AND METHOD

(71) Applicant: Giles Smallwood, Houston, TX (US)

(72) Inventor: Giles Smallwood, Houston, TX (US)

(21) Appl. No.: 16/167,404

(22) Filed: Oct. 22, 2018

Related U.S. Application Data
(60) Provisional application No. 62/575,266, filed on Oct. 20, 2017.

(51) Int. Cl. B25F 5/02; B25F 3/00

(52) U.S. Cl. CPC B25F 5/029; B25B 21/007; B25F 3/00

(57) ABSTRACT

An apparatus includes an upper half, a lower half coupled to the upper half and a securing mechanism. The apparatus attaches to a bottom of a cordless drill to provide quick and easy access to drill bits enabling users to keep their drill bits close at hand when working. The apparatus prevents individuals from wasting time trying to locate drill bits and eliminates the need to ask other individuals for assistance in locating the correct drill bit.

### CROSS REFERENCE TO RELATED APPLICATION

The present application is related to and claims priority to U.S. Provisional Patent Application No. 62/575,266 filed Oct. 20, 2017 which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of power tools and more specifically relates to a drill bit housing for use with a power tool.

### 2. DESCRIPTION OF RELATED ART

When on a job, it can take time to find the tools and materials that are needed. Locating the correct drill bit can be a time-consuming process, especially when working on a ladder and having to climb up and down to retrieve it or having to ask others for assistance. Due to their size, many drill bits are misplaced, and individuals often spend money to replace them. A suitable solution is desired.

U.S. Pat. No. 5,810,525 to Tommie L. Ector, Sr. relates to a tool and bit band for drills. The described tool and bit band for drills includes a tool holding assembly for placement around a handle portion and/or a body portion of a portable hand drill. The assembly includes a first elastic sleeve and a second elastic sleeve which are adapted for placement over the handle portion of the drill. The second sleeve partially overlaps the first sleeve, thereby providing additional tension to retain drill bits and other tools against the handle portion of the drill. The assembly may also include a third elastic sleeve which is adapted for placement over the body portion of the drill, and which is particularly disposed for retaining an elongate shank of a drill bit or the like. Together the various sleeves allow drill accessories such as drill bits, drill gimlets, and related tools to be retained upon the drill by tension of the elastic sleeves against the drill. The elastic sleeves are formed of any resilient material, however, rubber is preferred.

### BRIEF SUMMARY OF THE INVENTION

In view of the foregoing disadvantages inherent in the known power tools art, the present disclosure provides a novel an apparatus for use with a power tool and method. The general purpose of the present disclosure, which will be described subsequently in greater detail, is to provide an apparatus which attaches to a bottom of a cordless drill to provide quick and easy access to drill bits. The apparatus may appeal to anyone working on a construction job or home project as it enables users to keep their drill bits close at hand when working. This further may prevent individuals from wasting time trying to locate drill bits or spending money on bits they already bought. In addition to this, the apparatus may eliminate the need to ask other individuals for assistance in locating the correct drill bit when on a ladder.

An apparatus is disclosed herein. The apparatus includes an upper half which may have a first cavity; a lower half which may have a second cavity and coupled to the upper half; and a securing mechanism securing the upper half to the lower half.

A method of using apparatus is also disclosed herein. The method of using apparatus may comprise the steps of: providing the apparatus as above; placing a plurality of first-cavity-drill bits in the plurality of first-cavity indents; and placing a plurality of second-cavity-drill bits in the plurality of second-cavity indents.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for use with a power tool and method, constructed and operative according to the teachings of the present disclosure.

FIG. 1 is a side perspective view of the apparatus during an ‘in-use’ condition, according to an embodiment of the disclosure.

FIG. 2 is a front-side perspective view of the apparatus of FIG. 1, according to an embodiment of the present disclosure.

FIG. 3A is a front perspective view of the apparatus of FIG. 1, according to an embodiment of the present disclosure.

FIG. 3B is a rear perspective view of the apparatus of FIG. 1, according to an embodiment of the present disclosure.

FIG. 3C is a top perspective view of the apparatus of FIG. 1, according to an embodiment of the present disclosure.

FIG. 4A is a front-side perspective view of the apparatus of FIG. 1, according to an embodiment of the present disclosure.

FIG. 4B is a top perspective view of the apparatus of FIG. 1, according to an embodiment of the present disclosure.

FIG. 5 is a flow diagram illustrating a method of use for the apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a power tools and more particularly to an apparatus for use with a power tool and method as used to improve the drill bit housing for use with a power tool.

Generally, disclosed is an apparatus which may provide a convenient location to store drill bits that keeps them accessible when needed. The apparatus may be comprised of a hard-plastic case where drill bits are stored. The case may be adhered to the outside of a cordless drill battery. The case may include a slide lock to ensure that it won't open. Further, the case may be adhered to the battery using hook and loop fasteners. The case may measure approximately the same size or slightly smaller than the battery (3″×4.5″). It may be ⅞″deep. A monogrammed option may be available. The exact specifications may vary.

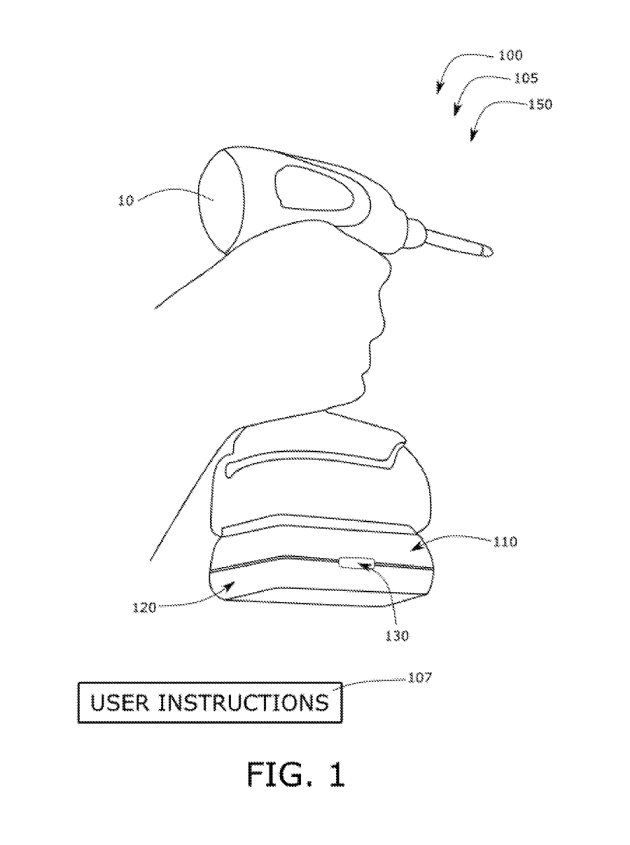

Referring now more specifically to the drawings by numerals of reference, there is shown in FIGS. 1-5, various views of an apparatus 100.

FIG. 1 shows an apparatus 100 during an ‘in-use’ condition 150, according to an embodiment of the present disclosure. As Illustrated, the apparatus 100 may include an upper half 110, a lower half 120 and a securing mechanism 130. As shown, the apparatus 100 may be attached to the power tool 10 and configured to store a plurality of drill bits.

According to one embodiment, the apparatus 100 may be arranged as a kit 105. The kit 105 may include set of user instructions 107. The instructions 107 may detail functional relationships in relation to the structure of the apparatus 100 (such that the apparatus 100 can be used, maintained, or the like, in a preferred manner).

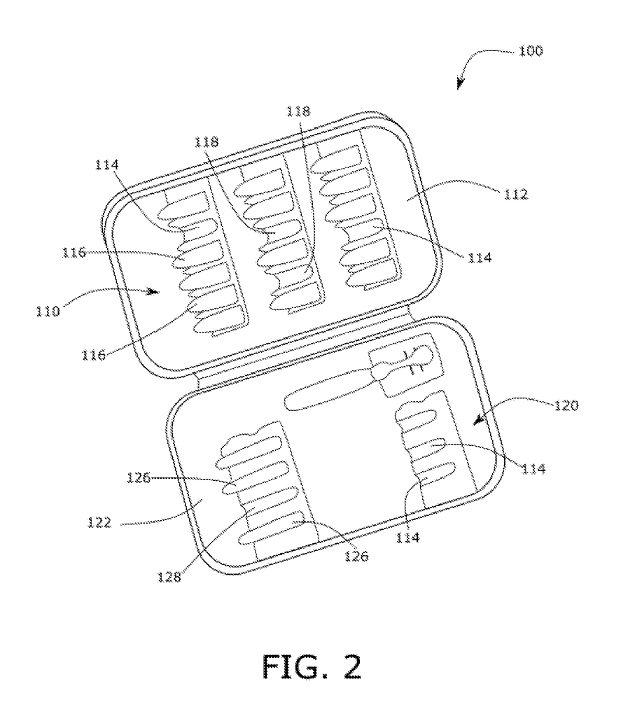

FIG. 2 shows a front-side perspective view of the apparatus 100 of FIG. 1, according to an embodiment of the present disclosure. As shown, the upper half 110 and the lower half 120 may be coupled together. The upper half 110 may have a first cavity 112 and the lower half 120 may have a second cavity 122. In one embodiment, the first cavity 112 may comprise a plurality of indents 114 configured to store first-cavity-drill bits 116. Similarly, the second cavity 122 may comprise a plurality of indents 114 configured to store second-cavity-drill bits 126.

In another embodiment, the apparatus 100 may further include a plurality of first-cavity-indents 118 and a plurality of second-cavity-indents 128 which may be removably attached to the first cavity 112 and the second cavity 122, respectively.

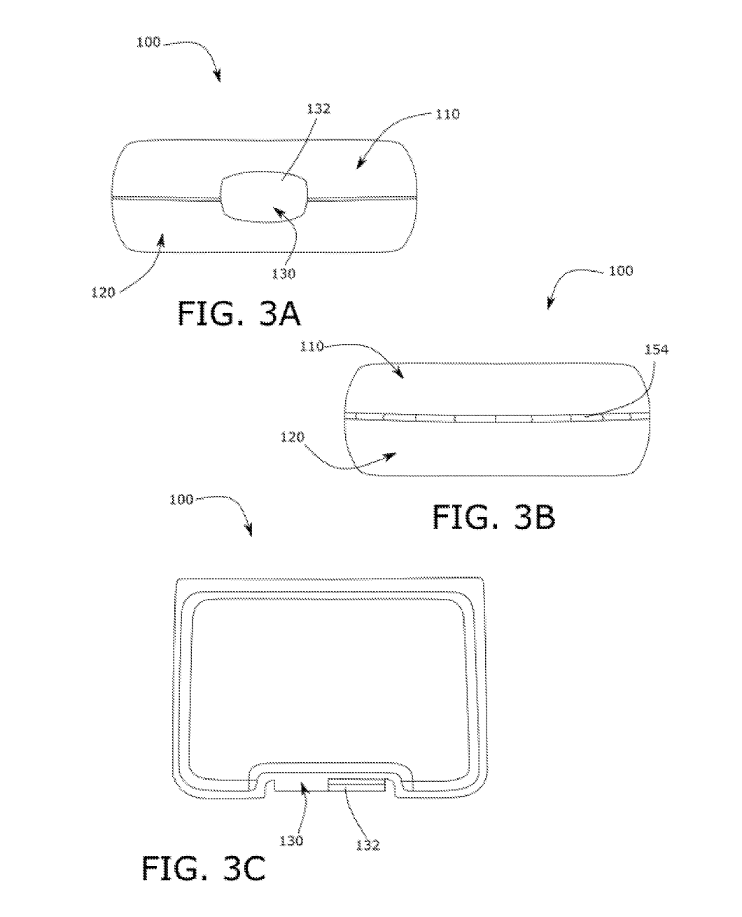

FIG. 3A-3C show front, top and rear perspective views of the apparatus 100 of FIG. 1, according to an embodiment of the present disclosure. As above, the lower half 120 may be coupled to the upper half 110. In one embodiment, the lower half 120 may hingedly coupled to the upper half 110 via a hinge 154. Further, the securing mechanism 130 may be provided to secure the upper half 110 to the lower half 120. In one example, the securing mechanism 130 may be a slide lock 132. However, other securing mechanisms 130 are contemplated, such as clasps, clamps, clips, snaps, etc. of a variety of sizes and shapes.

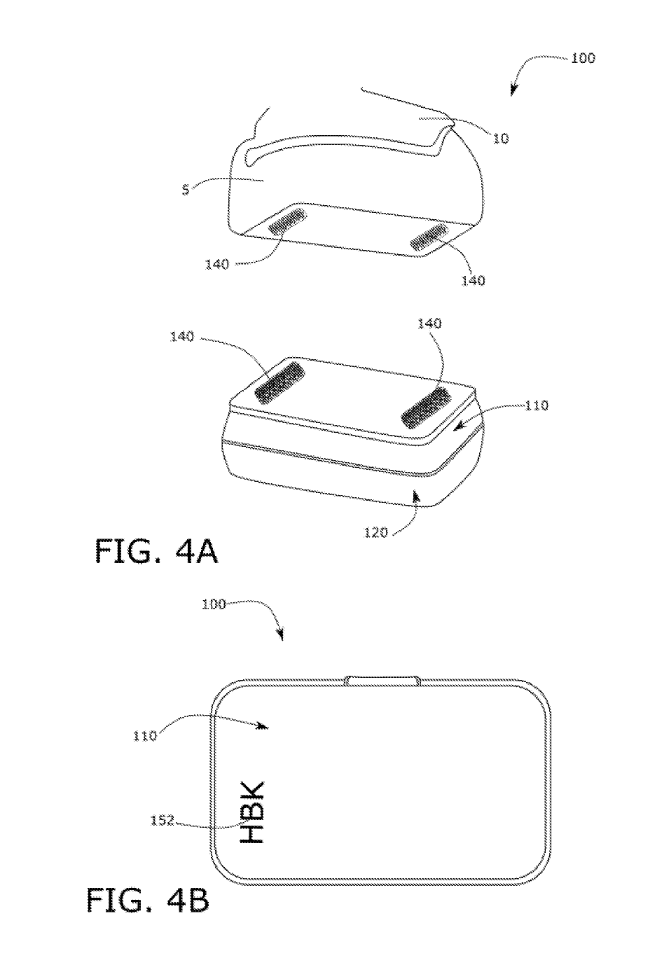

FIGS. 4A-4B shows front-side and top perspective views of the apparatus 100 of FIG. 1, according to an embodiment of the present disclosure. As shown, the apparatus 100 may be removably attached to a battery 5 of the power tool 10. In one version of this embodiment, the apparatus 100 may be smaller in size than the battery 5 of the power tool 10. However, in other examples, the apparatus 100 may be larger or equal in size. In one embodiment, the apparatus 100 may be removably attached to the battery 5 of the power tool 10 by means of a fastener 140. In one example, the fastener 140 may be a hook and loop fastener 140. However, other fasteners are contemplated such as zippers, snap fasteners, matable slots, etc.

The apparatus 100 may preferably be made from a hard-plastic material to provide durability. Types of plastic material contemplated may be high density polyethylene, acrylonitrile butadiene styrene, polyoxymethylene, etc. Other materials such as metal, rubber, silicone, etc., are also contemplated. Preferably, the apparatus 100 may be approximately ⅞ inches deep. Further, the upper half 110 and the lower half 120 may measure between 3-5 inches in width, and 3-6 inches in length. The apparatus 100 may preferably be substantially rectangular in shape (such that the length measures longer than the width), however, other shapes may be contemplated.

As shown in FIG. 4B, in some embodiments, the apparatus 100 may include a design 152 on a surface of the apparatus 100. The design 152 may be useful to add decoration to the apparatus 100 to aid in the appearance of the apparatus 100. In one embodiment, the design 152 may be a functional decoration. In this embodiment, the design 152 may be a monogram. The monogram may comprise the initials of an owner of the apparatus 100 so that the apparatus 100 is easily identifiable. This may be particularly useful for users of the apparatus 100 on a job site, where others may own and use the apparatus 100. Other design 152s contemplated may be patterns, colors, logos, etc.

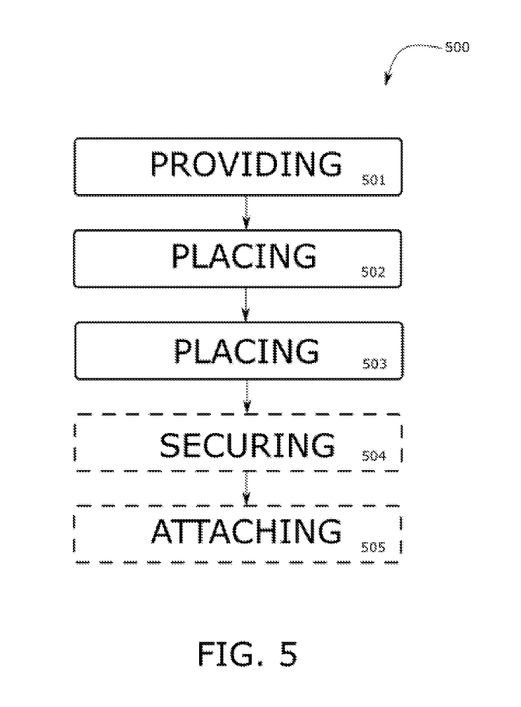

FIG. 5 is a flow diagram illustrating a method for using a case for storing drill bits on a power tool 500, according to an embodiment of the present disclosure. As illustrated, the method for using a case for storing drill bits on a power tool 500 may include the steps of: providing 501 the apparatus 100 as above; placing 502 a plurality of first-cavity-drill bits 116 in the plurality of first-cavity indents 118; and placing 503 a plurality of second-cavity-drill bits 126 in the plurality of second-cavity indents 128. Further steps may include securing 504 the upper half 110 of the case to the lower half 120 of the case by means of the slide lock 132 and attaching 505 the case to the battery 5 of the power tool 10.

It should be noted that steps 504 and 505 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders, according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for apparatus 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for use with a power tool, the apparatus comprising:
an upper half having a first cavity;
a lower half, said lower half having a second cavity and coupled to said upper half;
a securing mechanism, said securing mechanism securing said upper half to said lower half; and
wherein said apparatus for use with a power tool is configured to store a plurality of drill bits.

2. The apparatus of claim 1, wherein said lower half is hingedly coupled to said upper half.

3. The apparatus of claim 1, wherein said securing mechanism is a slide lock.

4. The apparatus of claim 1, wherein said first cavity comprises a plurality of indents.

5. The apparatus of claim 1, wherein said second cavity comprises a second plurality of indents.

6. The apparatus of claim 4, wherein said first plurality of indents is configured to store first-cavity-drill-bits.

7. The apparatus of claim 5, wherein said second plurality of indents is configured to store second-cavity-drill-bits.

8. The apparatus of claim 1, further comprising a plurality of first-cavity-indents and a plurality of second-cavity-indents, wherein said plurality of first-cavity-indents and said plurality of second-cavity-indents are removably attached to said first cavity and said second cavity.

9. The apparatus of claim 1, wherein said apparatus is removably attached to a battery of said power tool.

10. The apparatus of claim 9, wherein said apparatus is removably attached by means of a fastener.

11. The apparatus of claim 10, wherein said fastener is a hook and loop fastener.

12. The apparatus of claim 1, wherein said apparatus is made of a hard plastic.

13. The apparatus of claim 1, wherein said apparatus is smaller in size than said battery of said power tool.

14. The apparatus of claim 1, wherein said apparatus further comprises a design on a surface of said apparatus.

15. The apparatus of claim 14, wherein said design is a monogram.

16. The apparatus of claim 1, wherein said apparatus is approximately ⅞″deep.

17. A case for storing drill bits on a power tool, the case comprising:
an upper half having a first cavity;
a lower half, said lower half having a second cavity and coupled to said upper half;
a securing mechanism, said securing mechanism securing said upper half to said lower half;
wherein said lower half is hingedly coupled to said upper half;
wherein said securing mechanism is a slide lock;
wherein said first cavity comprises a plurality of indents;
wherein said second cavity comprises a plurality of indents;
wherein said plurality of indents is configured to store first-cavity-drill-bits;
wherein said plurality of indents is configured to store second-cavity-drill-bits;
wherein said apparatus is removably attached to a battery of said power tool;
wherein said apparatus is removably attached by means of a hook and loop fastener;
wherein said apparatus is made of a hard plastic;
wherein said apparatus is smaller than said battery;
wherein said apparatus further comprises a monogram on a surface of said apparatus; and
wherein said apparatus is approximately ⅞″deep.

18. The case of claim 17, further comprising a set of instructions;
wherein the case and instructions are arranged as a kit.

19. A method for using a case for storing drill bits on a power tool, the method comprising the steps of:
providing a case having an upper half having a first cavity, a lower half, said lower half having a second cavity and coupled to said upper half, a securing mechanism, said securing mechanism securing said upper half to said lower half,
wherein said lower half is hingedly coupled to said upper half, wherein said securing mechanism is a slide lock,
wherein said first cavity comprises a plurality of first-cavity-indents, wherein said second cavity comprises a plurality of second-cavity-indents,
wherein said plurality of first-cavity-indents is configured to store first-cavity-drill-bits,
wherein said plurality of second-cavity-indents is configured to store second-cavity-drill-bits, wherein said apparatus is removably attached to a battery of said power tool;
wherein said apparatus is removably attached by means of a hook and loop fastener,
wherein said apparatus is made of a hard plastic, wherein said apparatus is smaller than said battery,
wherein said apparatus further comprises a design on a surface of said apparatus, wherein said apparatus is approximately ⅞″deep;
placing a plurality of first-cavity-drill bits in said plurality of first-cavity indents;
placing a plurality of second-cavity-drill bits in said plurality of second-cavity indents;

20. The method of claim 19, further comprising the steps of:
securing said upper half of said case to said lower half of said case by means of said slide lock; and
attaching said case to said battery of said power tool.
